(19) United States
(12) Patent Application Publication
(10) Pub. No.: US 2022/0367938 A1
(43) Pub. Date: Nov. 17, 2022

(54) HEAT INSULATION SHEET FOR BATTERY PACK, AND BATTERY PACK

(71) Applicant: Ibiden Co., Ltd., Ogaki-shi, Gifu (JP)

(72) Inventors: Hisashi ANDO, lbi-gun, Gifu (JP); Naoki TAKAHASHI, lbi-gun, Gifu (JP)

(73) Assignee: Ibiden Co., Ltd., Ogaki-shi, Gifu (JP)

(21) Appl. No.: 17/767,277

(22) PCT Filed: Oct. 9, 2020
(86) PCT No.: PCT/JP2020/038290

§ 371 Date: Apr. 7, 2022

(30) Foreign Application Priority Data
Oct. 11, 2019 (JP) 2019-188199

(51) Int. Cl. H01M 10/658; H01M 10/653; H01M 10/613

(52) U.S. Cl. CPC H01M 10/658; H01M 10/653; H01M 10/613

(57) ABSTRACT

Provided is a heat insulation sheet for battery pack that can achieve uniform heat insulation property and heat dissipation property, and can insulate heat between adjacent battery cells and quickly dissipate heat generated by the battery cells when thermal runaway occurs in the battery cells, and a battery pack in which a heat insulation sheet for battery pack is interposed between battery cells. A heat insulation sheet (10) for battery pack in which battery cells are connected in series or in parallel, the heat insulation sheet being interposed between the battery cells and containing: a first particle (21) that is uniformly dispersed and contains a silica nanoparticle; and an inorganic fiber (23) that is uniformly dispersed and oriented in one direction which is parallel to a main surface of the heat insulation sheet (10).

### TECHNICAL FIELD

The present invention relates to a heat insulation sheet for battery pack interposed between battery cells of a battery pack, and a battery pack in which a heat insulation sheet for batters' pack is interposed between battery cells.

### BACKGROUND ART

In the related art, in order to prevent heat transmission from a heating element to another object, a heat insulation sheet for battery pack used in close proximity to the heating element or at least partially in contact with the heating element is used.

In recent years, a demand for lithium-ion secondary batteries capable of high capacity and high output compared with lead storage batteries, nickel-metal hydride batteries, and the like increases. The lithium-ion secondary batteries are used not only for small-capacity secondary batteries for mobile phones, personal computers, and small electronic devices, but also for large-capacity secondary batteries for automobiles, backup power supplies, and the like. Especially, in the field of automobiles, development of electric vehicles or hybrid vehicles driven by electric motors is actively promoted from the viewpoint of environmental protection. The electric vehicles, hybrid vehicles, and the like are equipped with a battery pack in which a plurality of battery cells is connected in series or in parallel to serve as a power source for a driving electric motor.

However, the lithium-ion secondary battery nay generate heat due to a chemical reaction during charging and discharging, and this causes a malfunction of the battery. For example, when a battery cell suddenly rises in temperature and causes thermal runaway, thermal runaway of the other battery cells may be caused by heat transmission to the other adjacent battery cells.

In the field of the battery pack as described above, in order to prevent heat transmission from the battery cell that causes the thermal runaway to adjacent battery cells and prevent problems of battery burning and explosion due to a chain of the thermal runaway, various heat insulation materials to be interposed between the battery cells are proposed.

For example, Patent Literature 1 describes a heat insulation material including a composite layer containing fibers and silica aerogel, and resin columns arranged in a thickness direction in the composite layer. According to such a heat insulation material, compressive stress applied to the heat insulation material can he dispersed by the resin columns, and a heat insulation property of the heat insulation material can he maintained. When the heat insulation material is used between battery cells, the compressive stress applied to the silica aerogel in the heat insulation material can be dispersed by the resin columns, and the heat insulation property between the battery cells can be maintained for a long period of time. It is described that as a result, it is possible to prevent the burning due to the thermal runaway between the battery cells and provide a safe in-vehicle battery, and heat conduction from the battery cells can be reduced by using a porous resin for the heat insulation resin columns.

### CITATION LIST

### Patent Literature

Patent Literature 1: JP-A-2017-215014

### SUMMARY OF INVENTION

### Technical Problem

However, since the heat insulation sheet has a high heat insulation property, when it comes into close contact with the battery cells, heat may be accumulated and thermal runaway of the battery cells may be promoted.

Furthermore, since the heat insulation sheet has different heat insulation properties between the resin columns in which aerogel does not exist and the composite layer in which aerogel exists, it is difficult to achieve uniform heat insulation property and heat dissipation property in the sheet. Therefore, transmission of heat generated from the battery cells is also different, and when thermal runaway occurs, it may not be possible to reduce heat transmission in the heat insulation sheet.

The present invention is made in view of the above-mentioned situation, and an object of the present invention is to provide a heat insulation sheet for battery pack that can achieve uniform heat insulation property and heat dissipation property, and can insulate heat between adjacent battery cells and quickly dissipate heat generated by the battery cells when thermal runaway occurs in the battery cells, and a battery pack in which a heat insulation sheet for battery pack is interposed between battery cells.

### Solution to Problem

The above object is achieved by a heat insulation sheet according to the present invention in the following (1).

(1) A heat insulation sheet for battery pack in which battery cells are connected in series or in parallel, the heat insulation sheet being interposed between the battery cells and containing:

a first particle that is uniformly dispersed and contains a silica nanoparticle; and

an inorganic fiber that is uniformly dispersed and oriented in one direction which is parallel to a main surface of the heat insulation sheet.

The heat insulation sheet of the present invention is preferably as the following (2) to (10).

(2) The heat insulation sheet for battery pack according to (1), in which

a content of the first particle is 30 mass % or more and 80 mass % or less with respect to a total mass of the heat insulation sheet for battery pack.

(3) The heat insulation sheet for battery pack according to (1) or (2), in which the first particle has an average, particle diameter of 1 nm or more and 100 nm or less.

(4) The heat it sheet for battery pack according to any one of (1) to (3), in which

a content of the inorganic fiber is 5 mass % or more and 30 mass % or less with respect to the total mass of the heat insulation sheet for battery pack.

(5) The heat insulation sheet for battery pack according to any one of (1) to (4), further including:

a second particle containing a metal oxide.

(6) The heat insulation sheet for battery pack according to (5), in which

the second particle is at least one kind selected from titania, zirconia, zircon, barium titanate, zinc oxide, and alumina.

(7) The heat insulation sheet for battery pack according to (6), in which the second particle is titania.

(8) The heat insulation sheet for battery pack according to any one of (5) to (7), in which

the second particle has an average particle diameter of 1 μm or more and 50 μm or less.

(9) The heat t ion sheet for battery pack according to any one of (1) to (8), further including a binder.

(10) The heat insulation sheet for battery pack according to (9), in which

the binder is at least one kind selected from methyl cellulose, water-soluble cellulose ether, hydroxypropyl methyl cellulose, carboxymethyl cellulose, hydroxyethyl cellulose, hydroxyethyl methyl cellulose, and derivatives thereof.

The above object is achieved by a battery pack according to the present invention in the following (11).

(11) A battery pack, in which

battery cells are arranged in a state where the battery cells interpose the heat insulation sheet for battery pack according to any one of (1) to (10), and

the battery cells are connected in series or in parallel.

The battery pack of the present invention is preferably as the following (12).

(12) The battery pack according to (11), further including:

a heat sink to dissipate heat generated from the battery cells, in which

in the heat insulation sheet for battery pack, the inorganic fiber is oriented toward the heat sink.

### Advantageous Effects of Invention

According to the present invention, because inside the heat insulation sheet for battery pack, the inorganic fiber is dispersed while being oriented in the direction parallel to the main surface, the heat insulation property and the heat dissipation property in the heat insulation sheet are excellent and uniform, and the heat generated by the battery cells can be dissipated by the heat insulation sheet. The heat insulation sheet for battery pack of the present invention can insulate heat from a battery to an adjacent battery even in a case of thermal runaway.

### BRIEF DESCRIPTION OF DRAW1NGS

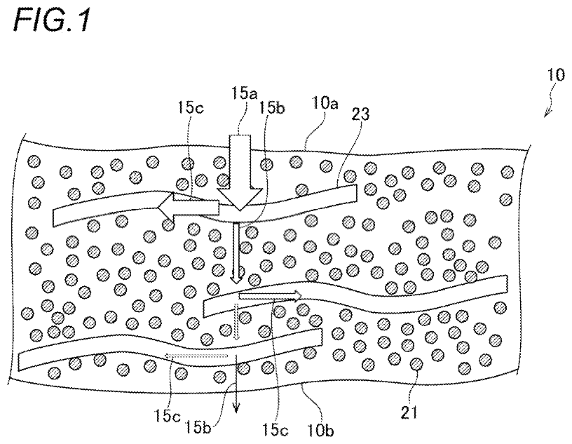

FIG. 1 is a schematic diagram showing a configuration of a heat insulation sheet for battery pack according to an embodiment of the present invention.

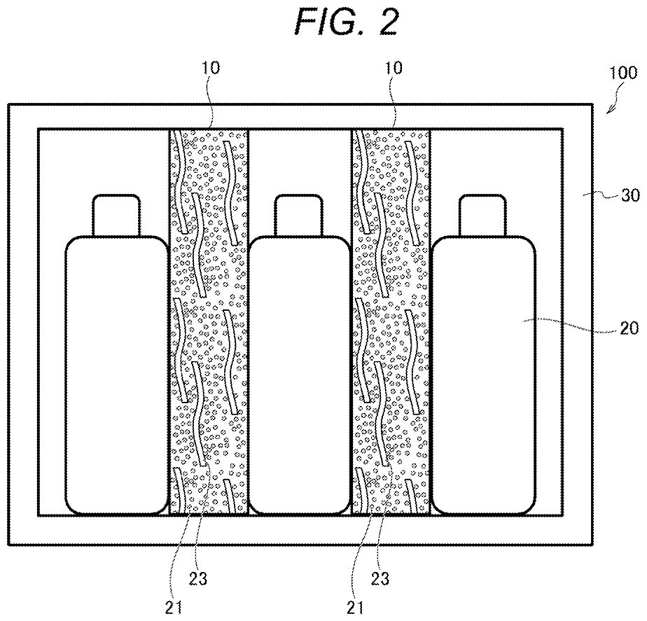

FIG. 2 is a cross-section schematically showing an embodiment of a battery pack using the heat insulation sheet for battery pack shown in FIG. 1.

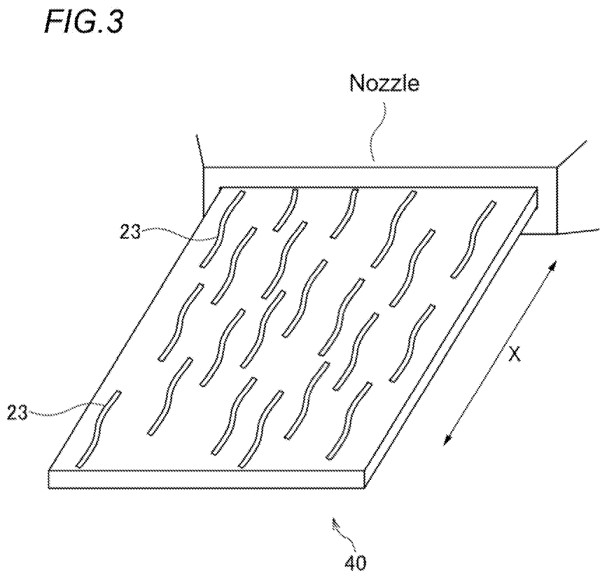

FIG. 3 is a perspective view schematically showing a heat insulation sheet for battery pack manufactured by extrusion molding.

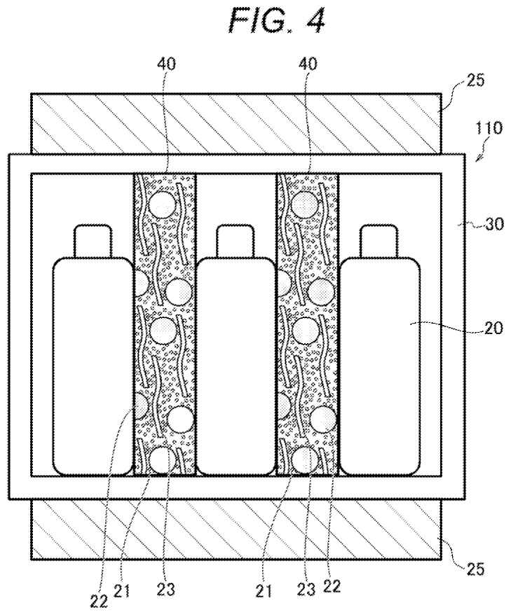

FIG. 4 is a cross-section schematically showing an embodiment of a battery pack using a heat insulation sheet including a second particle.

### DESCRIPTION OF EMBODIMENTS

As a result of diligent studies to provide a heat insulation sheet for battery pack having excellent heat insulation property and heat dissipation property that insulates heat between adjacent battery cells and quickly dissipates heat generated by the battery cells when thermal runaway occurs in the battery cells, inventors of the present application find that orientation of an inorganic fiber included in the heat insulation sheet is important. Because the heat insulation sheet for battery pack includes a first particle uniformly dispersed and containing a silica nanoparticle and an inorganic fiber uniformly dispersed and oriented in one direction parallel to a main surface of the heat insulation sheet, a high heat insulation property of the first particle and a heat dissipation property by the oriented inorganic fiber are combined, and the both excellent heat insulation property and heat dissipation property are obtained.

It is considered that since the silica nanoparticle, which is the first particle included in the heat insulation sheet for battery pack of the present invention, is an insulator, repulsive force due to static electricity tends to form fine voids between the particles, a bulk density is low, and the voids between the particles become heat resistance, a high heat insulation property can be ensured. When the silica nanoparticles are used in the heat insulation sheet for battery pack, a high heat insulation property can be obtained between the battery cells, but when it is used in close contact with the battery cells, the silica nanoparticles in the heat insulation sheet for battery pack may hinder heat dissipation and promote thermal runaway.

On the other hand, the inorganic fiber included in the heat insulation sheet for battery pack of the present invention has high heat conductivity and excellent heat dissipation property along an orientation direction of the inorganic fiber, but it has an excellent heat insulation property in a direction intersecting, the orientation direction.

In the present invention, silica nanoparticles and inorganic fibers having such characteristics are appropriately combined, and a heat insulation sheet for battery pack that easily dissipates heat from between battery cells to outside while ensuring a heat insulation property between battery cells is obtained.

The present invention is based on such findings, and a heat insulation sheet for battery pack and a battery pack according to an embodiment of the present invention (the present embodiment) will be described in detail with reference to the drawings.

<Basic Configuration of Heat Insulation Sheet for Battery Pack>

FIG. 1 is a schematic diagram showing a configuration of a heat insulation sheet 10 for battery pack according to an embodiment of the present invention, and FIG. 2 is a cross-section schematically showing an embodiment of a battery pack 100 using the heat insulation sheet 10 for battery pack shown in FIG. 1. The heat insulation sheet 10 includes a first particle 21 containing a silica nanoparticle and an inorganic fiber 23 containing glass fibers or the like. As the silica nanoparticle, a silica nanoparticle having an average particle diameter of 1 nm or more and 100 nm or less is used. The inorganic fiber 23 is mainly oriented in a lateral direction in a plan view.

As a specific embodiment using the heat insulation sheet 10 for battery pack, as shown in FIG. 2, battery cells 20 are arranged in a state where the battery cells interpose the heat insulation sheet 10 for battery pack, the battery cells 20 are housed in a battery case 30 in a state where the battery cells 20 are connected in series or in parallel (the connected state is not shown in the drawing), and the battery pack 100 is composed. As the battery cell 20, for example, a lithium ion secondary battery is preferably used, but the battery cell 20 is not particularly limited, and other secondary batteries may also be applied.

In the following description, it is assumed that there is a heat-generating battery cell 20 exists on one surface 10a side of the heat insulation sheet 10. In the heat insulation sheet 10 configured in this way, when the battery cell 20 generates heat, a part of the heat incident from the one surface 10a side of the heat insulation sheet 10 is conducted (solid conduction) toward the other surface 10b of the heat insulation sheet 10 as shown by arrows 15a in FIG. 1 by mediating the first particles 21, which are in contact with each other (since FIG. 1 is a schematic diagram, it is shown that the first particles 21 are not in contact with each other, but in reality, a plurality of first particles 21 is in point contact with each other), In this case, since silica nanoparticles having a heat insulation property are used as the first particles 21, an amount of conducted heat is reduced as approaching the other surface 10b of the heat insulation sheet 10 (see arrows 15b).

When the battery cell 20 generates heat and a part of the heat reaches the heat insulation sheet 10, as shown by arrows 15c, the inorganic fiber 23 diffuses the heat in the lateral direction in a plan view, and due to the presence of the inorganic fiber 23, the heat can be diffused to lateral sides of the heat insulation sheet while reducing the heat from being conducted to the other surface 10b of the heat insulation sheet 10.

In the present invention, “oriented in one direction” means that all the inorganic fibers 23 are not necessary to be oriented in that direction, and there is a strong tendency that the inorganic fibers 23 are aligned in a specific direction. The heat insulation sheet 10 for battery pack in which the inorganic fiber 23 is oriented in this way may be produced by using the originally oriented inorganic fiber 23 without any change, or may be obtained by stretching and orienting a raw material containing the randomly oriented inorganic fiber 23 in a uniaxial direction, or by forming a slurry into a sheet shape while orienting the slurry in which the inorganic fiber 23 is dispersed with a water stream.

It can be visually confirmed that the inorganic fiber 23 is oriented in a specific direction, but if it is difficult to discriminant the fiber, it also can be confirmed by measuring a bending strength in that direction and then judging whether the bending strength in the direction is 20% or more larger than those in other directions.

As described above, according to the present embodiment, even if a thermal runaway occurs in a certain battery cell 20, heat transmission to other adjacent battery cells 20 can be effectively prevented. Therefore, it is possible to prevent thermal runaway of the other battery cells 20 from being caused. Even when the battery cell 20 presses the heat insulation sheet 10 and adheres to the heat insulation sheet 10 by thermally expansion of the battery cell 20, the inorganic fiber 23 diffuses the heat to the lateral sides and can dissipate the heat while maintaining the excellent heat insulation property,

In the present embodiment, since the silica nanoparticles are used as the first particle 21 and contact points between the particles are small, an amount of heat conducted by the silica nanoparticles is smaller than that when silica particles having a large particle diameter are used Generally obtained silica nanoparticles contain many voids and have a bulk density of approximately 0.5 g/cm², for example, even when the battery cells 20 arranged on both sides of the heat insulation sheet 10 thermally expand and the heat insulation sheet 10 is slightly deformed by the pressure, the voids remain due to repulsive force between the particles, a size (an area) of the contact points between the silica nanoparticles does not become significantly large, and the heat insulation property can be maintained.

Further, in the present embodiment, since the voids formed between the particles of the silica nanoparticles are about several tens of nm, movement of air is hindered and convection heat transmission is reduced. Therefore, when the silica nanoparticles are used as the first particle 21, the heat insulation property of the heat insulation sheet 10 can be further improved.

>Details of Heat Insulation Sheet for Battery Pack>

Next, the first particle 21 and the inorganic fiber 23 constituting the heat insulation sheet 10 for battery pack will be described in detail.

(Kind of First Particle)

In the present invention, the silica nanoparticles are used as the first particle 21. As the silica nanoparticles, wet silica, dry silica, aerogel, and the like can be used.

In the present invention, the silica nanoparticles are nanometer-order silica particles having an average particle diameter of less than 1 μm, which are spherical or close to spherical.

(Content of First Particle: 30 Mass % or More and 80 Mass % or Less with Respect to Total Mass of Heat Insulation Sheet)

A content of the first particle 21 in the present invention is 30 mass % or more and 80 mass % or less with respect to a total mass of the heat insulation sheet for battery pack. Since the silica nanoparticles contained as the first particle 21 in the heat insulation sheet 10 have a low density, the silica nanoparticles reduce conduction heat transmission. Since the voids are finely dispersed, there is an excellent heat insulation property that movement of air is suppressed and convection heat transmission is decreased. Therefore, when the heat insulation sheet 10 for battery pack using the silica nanoparticles is used in close contact with the battery cells 20, heat would be accumulated to promote thermal runaway.

In the heat insulation sheet 10 for battery pack of the present invention, by setting the content of the first particle 21 to 30 mass % or more with respect to the total mass of the heat insulation sheet for battery pack, the heat insulation property is ensured, and by setting the content of the first particle 21 to 80 mass % or less, a space for containing the inorganic fiber 23 can be sufficiently ensured, and the thus heat dissipation property can be ensured.

(Average Particle Diameter of First Particle: 1 nm or More and 100 nm or Less)

As described above, a particle diameter of the first particle 21 may affect the heat insulation property of the heat insulation sheet 10. Therefore, when the average particle diameter of the first particle 21 is limited to a predetermined range, a higher heat insulation property can he obtained.

That is, when the average particle diameter of the first particle 21 is 1 nm or more and 100 nm or less, especially in a temperature range below 500° C., convection heat transmission and conduction heat transmission of the heat in the heat insulation sheet 10 can be reduced, and the heat insulation property can be further improved.

The average particle diameter of the first particle 21 is more preferably 2 nm or more, and still more preferably 3 nm or more. The average particle diameter of the first particle 21 is more preferably 50 nm or less, and still more preferably 10 nm or less.

(Content of Inorganic Fiber: 5 mass % or More and 30 Mass % or Less with Respect to Total Mass of Heat Insulation Sheet)

A content of the inorganic fiber 23 in the present invention is 5 mass % or more and 30 mass % or less with respect to the total mass of the heat insulation sheet for battery pack,

When the content of the inorganic fiber 23 is 5 mass % or more, the effect of diffusing heat to the lateral sides of the heat insulation sheet can be sufficiently ensured. When the content of the inorganic fiber 23 is 30 mass % or less, space for filling the first particle having a high heat insulation property can be sufficiently secured, and thus the heat insulation property can be ensured.

(Average Fiber Diameter of Inorganic Fiber: 1 μm or More and 20 μm or Less)

The inorganic fiber 23 is a linear or needle-shaped fiber having large-diameter, and contributes to improvement of mechanical strength and a shape retention property with respect to a pressure from the battery cell 20 of the heat insulation sheet 10. In order to obtain such an effect, an average fiber diameter thereof is preferably 1 μm or more, and more preferably 2 μm or more. However, if the inorganic fiber 23 is too thick, moldability and processability on the heat insulation sheet 10 may decrease, and therefore the average fiber diameter is preferably 20 μm or less, and more preferably 15 μm or less.

(Average Fiber Length of Inorganic Fiber: 0.1 mm or More and 300 mm or Less)

When the inorganic fiber 23 is used as a base material, the fibers are suitably entangled with each other when molded as the heat insulation sheet 10, and a sufficient surface pressure can be obtained. In order to obtain such an effect, when the inorganic fiber 23 is used, an average fiber length thereof is preferably 0.1 mm or more, and more preferably 1 mm or more. However, when a process of mixing the inorganic fiber 23 and the first particle 21 and after that, orienting the inorganic fiber 23 is adopted, if the average fiber length of the inorganic fiber 23 is too long, during preparation of raw materials, the entanglement between the inorganic fibers 23 may become too strong, and the inorganic fibers 23 may easily accumulate non-uniformly after being formed into a sheet. Therefore, the average fiber length of the inorganic fiber 23 is preferably 300 mm or less, and more preferably 20 mm or less.

If the heat insulation sheet 10 for battery pack contains a binder component, the fiber diameter and fiber length of the inorganic fiber 23 can be measured by extracting the inorganic fiber 23 from a molded sheet without breaking it using tweezers after removing the binder component with a solvent, and comparing it with a standard scale. if necessary, the fiber diameter and fiber length can be measured by observing with an optical microscope.

In addition to the first particle 21 and the inorganic fiber 23, the heat insulation sheet 10 for battery pack may contain a second particle 22 containing a metal oxide as a component that further enhances the heat insulation effect in a high temperature range of 500° C. or higher, and may further contain components necessary for molding into a heat insulation sheet, such as a binding material and a colorant. Hereinafter, other components will be described in detail.

(Kind of Second Particle)

In the present invention, a metal oxide is used as the second particle 22. As the metal oxide, titania, zirconia, zircon, barium titanate, zinc oxide, alumina, or the like can be used. Particularly, titania is a component having a higher refractive index than other metal oxides, and has a high effect of diffusely reflecting heat in a high temperature range of 500° C. or higher. Therefore, it is most preferable to use titania.

(Average Particle Diameter of Second Particle: 1 μm or More and 50 μm or Less)

Since a particle diameter of the second particle 22 may affect an effect of reflecting heat, when the average particle diameter of the second particle 22 is limited to a predetermined range, a higher heat insulation property can be obtained.

That is, when the average particle diameter of the second particle 22 is 1 μm or more, the average particle diameter is sufficiently larger than a wavelength of light that contributes to heating, and the light is efficiently diffusely reflected, and in an existence range (mass ratio) of the second particle 22 in the present invention, radiation heat transmission of the heat in the heat insulation sheet 10 is reduced in a high temperature range of 500° C. or higher, and the heat insulation property can be further improved. When the average particle diameter of the second particle 22 is 50 μm or less, even if it is compressed, the number of contact points between the particles does not increase, it is difficult to form a path for conduction heat transmission, and influence on the heat insulation property in a normal temperature range where the conduction heat transmission is particularly dominant can be reduced.

The average particle diameter of the second particle 22 is more preferably 3 μm or more, and still more preferably 5 μm or more. The average particle diameter of the second particle 22 is more preferably 30 μm or less, and still more preferably 10 μm or less.

In the present invention, the average particle diameter can be obtained by observing the particles with a microscope, comparing the particles with a standard scale, and taking an average value of any 10 particles.

(Content of Second Particle 22: 5 mass % or More and 40 mass % or Less with Respect to Total Mass of Heat Insulation Sheet)

In the present invention, in order to improve the heat insulation property in a high temperature range of 500° C. or higher, although it is preferable that the heat insulation sheet 10 contains the second particle 22, even if an adding amount of the second particle 22 is small, the effect of reducing radiation heat transmission also can be obtained. In order to obtain the effect of reducing convection heat transmission and conduction heat transmission by the first particle 21, it is preferable to increase an adding amount of the first particle 21. In this way, a mass ratio of the second particle 22 affects the heat insulation property in a range from a normal temperature to a high temperature of 500° C. or higher. Therefore, in the present invention, when the heat insulation sheet 10 contains a metal oxide as the second particle 22, it is preferable to appropriately adjust the mass ratio of the second particle 22.

In the heat insulation sheet 10 of the present invention, a desirable mass ratio of the second particle 22 is 5 mass % or more with respect to the total mass of the heat insulation sheet. When the content of the second particle 22 is 5 mass % or more with respect to the total mass of the heat insulation sheet, it is considered that radiation heat transmission can be reduced in particularly a temperature range of 500° C. or higher where influence of radiation is large, and a high heat insulation property can be obtained.

The desirable mass ratio of the second particle 22 of the heat. insulation sheet 10 of the present invention is 40 mass % or less with respect to the total mass of the heat insulation sheet. When the content of the second particle 22 exceeds 40 mass % with respect to the total mass of the heat insulation sheet, a sufficient effect of the first particle 21 may not be achieved, it becomes difficult to reduce the convection heat transmission or solid conduction of heat in the heat insulation sheet 10 in a temperature range of less than 500° C., and the heat insulation property may be reduced.

(Binder: 3 mass % or More and 30 Mass % or Less)

In the present invention, since, the inorganic fiber 23 is included together with the silica nanoparticles as the first particle 21, the inorganic fiber 23 can maintain a shape of the heat insulation sheet 10. However, in order to prevent the silica nanoparticles from falling, it is preferable to add a binder in an appropriate content.

When a content of the binder is 3 mass % or more with respect to the total mass of the heat insulation sheet 10. it is possible to reduce falling of the silica nanoparticles from the heat insulation sheet 10. The content of the binder with respect to the total mass of the heat insulation sheet 10 is preferably 5 mass % or more.

On the other hand, since the binder acts to bond the first particles 21 against the repulsive force due to static electricity of the first particles 21, it becomes difficult to reduce solid conduction, and the heat insulation property may be decreased. Therefore, the content of the binder with respect to the total mass of the heat insulation sheet is preferably 30 mass % or less, and more preferably 20 mass % or less.

(Kind of Binder)

As described above, in the heat insulation sheet 10 for battery pack according to the present invention, it is preferable to appropriately select the kind and content of the binder in order to adjust a compression property to a desired. value, As the binder, an organic binder, an inorganic binder, or the like can be used. in the present invention, particularly as the organic binder, it is preferable to use methyl cellulose, water-soluble cellulose ether, hydroxypropyl methyl cellulose, carboxymethyl cellulose, hydroxyethyl cellulose, hydroxyethyl methyl cellulose, and derivatives thereof. The kind of the inorganic binder is not particularly limited, but as the inorganic binder, for example, alumina sol, silica sol, or the like can be used.

(Thickness of Heat Insulation Sheet: 0.1 mm or More and 30 mm or Less)

A thickness of the heat insulation sheet 10 for battery pack according to the present invention is not particularly limited, but is preferably in a range of 0.1 mm or more and 30 mm or less. When the thickness of the heat insulation sheet 10 is within the above range, sufficient mechanical strength can be obtained and molding can be easily performed.

(Method for Manufacturing Heat Insulation Sheet for Battery Pack)

Next, a method for manufacturing the heat insulation sheet 10 for battery pack according to the present invention will be described in detail.

The heat insulation sheet 10 according to the present embodiment may be manufactured by molding materials for the heat insulation sheet including the first particle 21 and the inorganic fiber 23 by an extrusion molding method, a wet sheet forming method, a press molding method, or the like. Hereinafter, a manufacturing method under a case where the heat insulation sheet 10 is obtained by each molding method will be described.

[Manufacturing Method of Heat Insulation Sheet by Extrusion Molding Method]

In the extrusion molding method, the first particle 21 and the inorganic fiber 23, and if necessary, the second particle 22 and a binder, are added with a solvent such as water and kneaded to prepare a paste-like raw material. Then, a green sheet can be obtained by extruding the obtained paste-like raw material from a nozzle of an extrusion molding machine, Further, the obtained green sheet is dried and cut into an appropriate size to obtain the heat insulation sheet 10 for battery pack of the present invention, As described above, as the organic binder, methyl cellulose, water-soluble cellulose ether, and the like are preferably used, but any organic binder generally used when an extrusion molding method is used can be used without particular limitation.

FIG. 3 is a perspective view schematically showing a heat insulation sheet 40 for battery pack manufactured by extrusion molding, in FIG. 3, the first particle 21 is not shown. As shown in FIG. 3, when the heat insulation sheet 40 is manufactured by the extrusion molding method, the inorganic fiber 23 and the like contained as materials of the heat insulation sheet 40 are oriented in an extrusion direction X, that is, in one direction parallel to the main surface of the heat insulation sheet. Since the heat insulation sheet 40 is given anisotropy in heat conductivity by the inorganic fiber 23 and the like oriented in this way, heat incident from the main surface side of the heat insulation sheet 40 is transmitted in one direction parallel to the main surface. Therefore, when the heat insulation sheet 40 manufactured by the extrusion molding method is used, heat transmission to the adjacent battery cells 20 can be prevented more effectively and heat can be dissipated efficiently.

[Manufacturing Method of Heat Insulation Sheet by Wet Sheet Forming Method]

In the wet sheet forming method, a mixed liquid is prepared by mixing the first particle 21 and the inorganic fiber 23, and if necessary, the second particle 22 and a binder, in water, and stirring with a stirrer. Then, the obtained mixed liquid is poured into a molding machine provided with a mesh for filtration on a bottom surface thereof, and the mixed liquid is dehydrated through the mesh to prepare a wet sheet. In this case, by arranging the mesh for filtration in an inclined manner rather than horizontally, the mixed liquid is formed into a sheet while flowing in one direction, so that a wet sheet in which the inorganic fiber 23 is oriented in the inclined direction can he obtained. Then, the heat insulation sheet 40 can be obtained by heating and pressurizing the obtained wet sheet. Before the heating and pressurizing, hot air may be aerated through the wet sheet to dry the sheet, but this aeration-drying treatment may also not be carried out, and the wet sheet may be heated and pressurized in a wet state.

[Manufacturing Method of Heat Insulation Sheet by Press Molding Method]

In the press molding method, the first particle 21, and if necessary, the second particle 22, a binder, and a solvent are stirred with a stirrer to prepare a slurry-like raw material. A sliver of an inorganic fiber is prepared separately, and the slurry-like raw material is infiltrated between fibers of the sliver. After the obtained infiltrated body is dried, the heat insulation sheet 40 for battery pack of the present invention can be obtained by press molding. The sliver is a thick string-like aggregate in which fibers are oriented in one direction. By arranging a plurality of slivers as needed, a flat plate-shaped heat insulation sheet 40 can be obtained,

The heat insulation sheet 40 for battery pack of the present invention is not limited to these manufacturing methods, and can be used by any manufacturing method.

<Battery Pack>

As illustrated in FIG. 2, in the battery pack 100 according to the present invention, battery cells 20 are arranged in a state where the battery cells interpose the heat insulation sheet 10 for battery pack, and the battery cells 20 are connected in series or in parallel.

FIG. 4 is a cross-section schematically showing an embodiment of the battery pack 110 using the heat insulation sheet 40 for battery pack shown in. FIG. 3. In FIG. 4. the same elements as those in FIG. 2 are designated by the same reference numerals, and detailed description thereof will be omitted. As shown in FIG. 4, the battery pack. 110 according to the present embodiment includes a metal battery case 30 that dissipates heat generated from the battery cells 20 to an outer side where the plurality of battery cells 20 and the heat insulation sheet 40 for battery pack are arranged. A heat sink 25 for releasing heat to the outer side is arranged outside the battery case 30.

Here, when the battery pack 110 includes the metal battery case 30, the heat generated from the battery cells .20 is transferred to the heat insulation sheet 40 and then diffused to the lateral sides and transmitted to the battery case 30. In this case, when the heat insulation sheet 40 for battery pack includes the inorganic fiber 23 and the inorganic fiber 23 is oriented in a vertical direction (that is, a direction perpendicular to a stacking direction of the battery cells 20), the heat transmitted from the battery cells 20 is likely to be transmitted in the vertical direction through the oriented inorganic fiber 23, and is easily dissipated by the battery case 30 and the heat sink 25. Therefore, when the heat insulation sheet 40 is molded by, for example, extrusion molding and includes the inorganic fiber 23 oriented in one direction parallel to the main surface thereof, it is preferable to incorporate the heat insulation sheet into the battery pack 110 in consideration of an orientation direction thereof.

In FIG. 4, the battery case 30 is arranged so that areas of an upper surface and a bottom surface thereof are large. Therefore, the orientation direction of the heat insulation sheet 40 for battery pack is set to the vertical direction so that heat can be easily dissipated from the upper surface and the bottom surface, but the orientation direction of the inorganic fiber 23 is not limited to a direction of a large surface, and it is desirable to orient the inorganic fiber 23 in a direction in which heat can be easily released.. For example, when the battery pack is fixed by a metal fixture that functions as the heat sink 25, the orientation direction of the inorganic fiber 23 may he a direction in which the heat sink is located.

That is, when the heat insulation sheet 40 is arranged such that the inorganic fiber 23 in the heat insulation sheet 40 is oriented toward a direction of the heat sink 25, it is possible to further insulate heat while improving the heat dissipation property by the heat insulation sheet 40. The heat may be dissipated to a heat storage material or the like but not limited to the heat sink 25.

Although various embodiments have been described above with reference to the drawings, it is needless to say that the present invention is not limited to such examples. It is apparent to those skilled in the art that various changes and modifications can be conceived within the scope of the claims, and it is also understood that such variations and modifications belong to the technical scope of the present invention. In addition, constituent elements in the embodiments described above may be combined freely within a range not departing from the spirit of the present invention.

The present application is based on Japanese Patent Application No. 2019-188199 filed on Oct. 11, 2019, the contents of which are incorporated herein by reference.

### REFERENCE SIGNS UST

10, 40: heat insulation sheet (heat insulation sheet for battery pack)

10a, 10b: surface

20: battery cell

21: first particle

22: second particle

23: inorganic fiber

25: heat sink

30: battery case

100, 110: battery pack.

1. A heat insulation sheet for battery pack in which battery cells are connected in series or in parallel, the heat insulation sheet being interposed between the battery cells and comprising:
a first particle that is uniformly dispersed and contains a silica nanoparticle; and
an inorganic fiber that is uniformly dispersed and oriented in one direction which is parallel to a main surface of the heat insulation sheet.

2. The heat insulation sheet for battery pack according to claim 1, wherein
a content of the first particle is 30 mass % or more and 80 mass % or less with respect to a total mass of the heat insulation sheet for battery pack.

3. The heat insulation sheet for battery pack according to claim 1, wherein
the first particle has an average particle diameter of 1 nm or more and 100 nm or less.

4. The heat insulation sheet for battery pack according to claim 1, wherein
a content of the inorganic fiber is 5 mass % or more and 30 mass % or less with respect to the total mass of the heat insulation sheet for battery pack.

5. The heat insulation sheet for battery pack according to claim 1, further comprising a second particle containing a metal oxide.

6. The heat insulation sheet for battery pack according to claim 5, wherein
the second particle is at least one kind selected from titania, zirconia, zircon, barium titanate, zinc oxide, and alumina.

7. The heat insulation sheet for battery pack according to claim 6, wherein
the second particle is titania.

8. The heat insulation sheet for battery pack according to claim 5, wherein
the second particle has an average particle diameter of 1 μm or more and 50 μm or less.

9. The heat insulation sheet for battery pack according to claim 1, further comprising a binder.

10. The heat insulation sheet for battery pack according to claim 9, wherein
the binder is at least one kind selected from methyl cellulose, water-soluble cellulose ether, hydroxypropyl methyl cellulose, carboxymethyl cellulose, hydroxyethyl cellulose, hydroxyethyl methyl cellulose, and derivatives thereof.

11. A battery pack, wherein
battery cells are arranged in a state where the battery cells interpose the heat insulation sheet for battery pack according to claim 1, and
the battery cells are connected in series or in parallel.

12. The battery pack according to claim 11, further comprising:
a heat sink to dissipate heat generated from the battery cells, wherein
in the heat insulation sheet for battery pack, the inorganic fiber is oriented toward the heat sink.

13. The heat insulation sheet for battery pack according to claim 2, wherein the first particle has an average particle diameter of 1 nm or more and 100 nm or less.

14. The heat insulation sheet for battery pack according to claim 2, wherein
a content of the inorganic fiber is 5 mass % or more and 30 mass % or less with respect to the total mass of the heat insulation sheet for battery pack.

15. The heat insulation sheet for battery pack according to claim 3, wherein
a content of the inorganic fiber is 5 mass % or more and 30 mass % or less with respect to the total mass of the heat insulation sheet for battery pack.

16. The heat insulation sheet for battery pack according to claim 4, wherein
a content of the inorganic fiber is 5 mass % or more and 30 mass % or less with respect to the total mass of the heat insulation sheet for battery pack.
